(19) United States
(12) Patent Application Publication
(10) Pub. No.: US 2024/0128917 A1
(43) Pub. Date: Apr. 18, 2024

(54) MOTOR DRIVE DEVICE AND OUTDOOR UNIT OF AIR-CONDITIONING APPARATUS, WHICH INCLUDES THE SAME

(71) Applicant: Mitsubishi Electric Corporation, Tokyo (JP)

(72) Inventors: Yoshihiro TANIGUCHI, Tokyo (JP); Naoki YAMADA, Tokyo (JP); Kazuyoshi MORIMOTO, Tokyo (JP)

(21) Appl. No.: 18/547,896

(22) PCT Filed: May 11, 2021
(86) PCT No.: PCT/JP2021/017892

§ 371 Date: Aug. 25, 2023

(51) Int. Cl. H02P 29/032; F24F 1/08; H02P 29/024

(52) U.S. Cl. CPC H02P 29/032; F24F 1/08; H02P 29/027

(57) ABSTRACT

A motor drive device includes: an inverter circuit configured to drive a motor; a drive circuit to which a control voltage is applied, the drive circuit being configured to output a drive signal to the inverter circuit; and a relay configured to stop application of the control voltage to the drive circuit. The relay is configured to detect a motor current that is output from the inverter circuit to the motor, and to stop application of the control voltage to the drive circuit when the motor current reaches a first threshold or higher that is determined in advance.

### TECHNICAL FIELD

The present disclosure relates to a motor drive device that drives a motor, and also relates to an outdoor unit of an air-conditioning apparatus, which includes the motor drive device.

### BACKGROUND ART

In the past, a compressor drive device has been known that includes a semiconductor element configured to drive a motor of the compressor, a power supply circuit configured to supply a DC power to the semiconductor element, and a temperature sensor configured to detect heat of an outer shell of the compressor in order to prevent overload on the compressor (see, for example, Patent Literature 1). In the compressor drive device disclosed in Patent Literature 1, the temperature sensor is connected to a line through which the DC power is supplied from the power supply circuit to the semiconductor element. When detecting a temperature higher than or equal to a predetermined temperature, the temperature sensor shuts off the DC power source. As a result, the operation of the compressor is stopped.

An overheat protection system of the compressor drive device disclosed in Patent Literature 1 operates when the temperature of an outer shell of the compressor reaches a predetermined temperature or higher. However, the temperature sensor detects a temperature of an outer shell of the motor, and the temperature of the outer shell of the motor may be greatly different from the actual temperature of a winding in the motor. For example, in the case where an ambient temperature around the compressor is high, even when the temperature of the winding in the motor is low, the temperature sensor may detect a temperature higher than or equal to the predetermined temperature. As a result, the operation of the compressor may be stopped.

As another example of the overheat protection system, an electromagnetic switch in which an electromagnetic contactor and a thermal relay are combined is used in factory automation (FA) (see, for example, Patent Literature 2). In the case where the electromagnetic contactor in Patent Literature 2 is used as an overheat protection system for the compressor, current detection circuitry in the thermal relay and the electromagnetic contactor are attached to a power line between the motor and an inverter. When an overcurrent flows through the power line, the current detection circuitry in the thermal relay is activated and relay circuitry of the thermal relay thus operates. When the relay circuitry operates, the electromagnetic contactor is activated, and the power line between the motor and the inverter is thus shut off.

### CITATION LIST

### Patent Literature

Patent Literature 1: Japanese Unexamined Patent Application Publication No. 2014-177880
Patent Literature 2: Japanese Unexamined Patent Application Publication No. Hei 06-139893

### SUMMARY OF INVENTION

### Technical Problem

In the overheat protection system disclosed in Patent Literature 1, the effect of an environmental temperature that is an ambient temperature around the compressor is great. In contrast, the electromagnetic switch disclosed in Patent Literature 2 uses the electromagnetic contactor to shut off the power line, thus increasing production costs of a device that drives the motor of the compressor.

The present disclosure is made to solve the above problems, and relates to a motor drive device that is not greatly affected by an environmental temperature, and that is produced at lower costs, and also to provide an outdoor unit of an air-conditioning apparatus, which is provided with the motor drive device.

### Solution to Problem

A motor drive device according to one embodiment of the present disclosure includes: an inverter circuit configured to drive a motor, a drive circuit to which a control voltage is applied, the drive circuit being configured to output a drive signal to the inverter circuit; and a relay configured to stop application of the control voltage to the drive circuit. The relay is configured to detect a motor current that is output from the inverter circuit to the motor, and to stop application of the control voltage to the drive circuit when the motor current reaches a first threshold or higher that is determined in advance.

An outdoor unit of an air-conditioning apparatus according to another embodiment of the present disclosure includes: an actuator forming part of a refrigeration cycle circuit; a motor provided in the actuator, and the motor drive device configured to drive the motor.

### Advantageous Effects of Invention

According to the embodiments of the present disclosure, even though an electromagnetic contactor configured to stop the supply of a motor current is not provided at a power line through which the motor current is supplied to the motor, when the motor current reaches the first threshold or higher, the relay stops application of the control voltage to the drive circuit, and can thus stop the output from the inverter circuit.

It is therefore possible to not only reduce production costs of a product, but also improve the reliability of protection from an overcurrent since the product is not greatly affected by an environmental temperature.

### BRIEF DESCRIPTION OF DRAWINGS

FIG. 1 is a refrigerant circuit diagram illustrating a configuration example of an air-conditioning apparatus including an outdoor unit according to Embodiment 1.

FIG. 2 illustrates a configuration example of a controller including a motor drive device according to Embodiment 1.

FIG. 3 is a circuit diagram illustrating a configuration example of an inverter circuit as illustrated in FIG. 2.

FIG. 4 is a schematic diagram illustrating an example of an operating principle of relay circuitry.

### DESCRIPTION OF EMBODIMENTS

### Embodiment 1

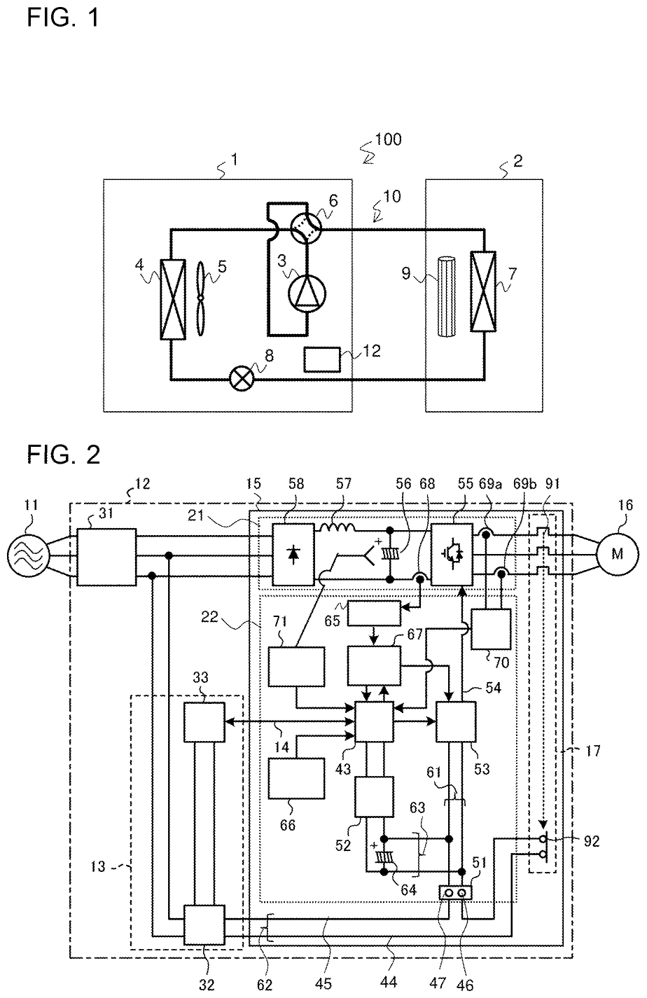

A configuration of an air-conditioning apparatus according to Embodiment 1 will be described below. FIG. 1 is a refrigerant circuit diagram illustrating a configuration example of the air-conditioning apparatus including an outdoor unit according to Embodiment 1. FIG. 2 illustrates a configuration example of a controller including a motor drive device according to Embodiment 1.

As illustrated in FIG. 1, an air-conditioning apparatus 100 includes an outdoor unit 1 and an indoor unit 2. The outdoor unit 1 includes a compressor 3, a heat-source-side heat exchanger 4, a fan 5, a four-way valve 6, an expansion valve 8, and a controller 12. The indoor unit 2 includes a load-side heat exchanger 7 and a fan 9. The expansion valve 8 is, for example, an electronic expansion valve. The controller 12 is connected to the compressor 3, the fan 5, the four-way valve 6, the expansion valve 8, and the fan 9 by lines (not illustrated). The compressor 3 compresses sucked refrigerant and discharges the compressed refrigerant. The compressor 3 is, for example, an inverter compressor whose capacity can be changed. The fan 5 supplies outside air to the heat-source-side heat exchanger 4. The heat-source-side heat exchanger 4 causes heat exchange to be performed between refrigerant and the outside air.

The compressor 3, the heat-source-side heat exchanger 4, the expansion valve 8, and the load-side heat exchanger 7 are connected by refrigerant pipes, whereby a refrigerant circuit 10 is formed. In the refrigerant circuit 10, refrigerant circulates. The compressor 3, the heat-source-side heat exchanger 4, the fan 5, the expansion valve 8, the load-side heat exchanger 7, and the fan 9 form a refrigeration cycle circuit.

With reference to FIG. 2, the configuration of the controller 12 in Embodiment 1 will be described below. The controller 12 includes a noise filter circuit 31 connected to a power supply system 11 located outside the controller 12, a main substrate 13, and a motor drive device 15 that drives a motor 16. The motor 16 is used for one or both of the compressor 3 and the fan 5 as illustrated in FIG. 1 that are provided as actuators.

The power supply system 11 is an AC power source. Although FIG. 2 illustrates the power supply system 11 as a three-phase three-wire power supply, the power supply system 11 may be a three-phase four-wire power supply, or may be a single-phase power supply. The voltage of the power supply system 11 is, for example, 200 V, but may be 400 V or higher. The withstanding voltages of components in the controller 12 are different and vary depending on the voltage of the power supply system 11. However, in Embodiment 1, the withstand voltage will be described simply as a power supply voltage without taking into consideration the specifications of the components in the controller 12.

The noise filter circuit 31 includes an anti-lightning-surge element (not illustrated) that prevents the main substrate 13 and the motor drive device 15 from being broken by a surge voltage of, for example, lightning from the power supply system 11, and an anti-noise element (not illustrated) that removes noise generated by semiconductor switching in the inverter. The anti-lightning-surge element is, for example, an arrester, a variable resistor, or a fuse. The anti-noise element is, for example, a common-mode choke coil or a high withstand-voltage film capacitor.

The noise filter circuit 31 is connected to the power supply system 11 by three input lines, and connected to the motor drive device 15 by three output lines. The main substrate 13 is connected to the noise filter circuit 31 in parallel with the motor drive device 15 by two of the three output lines of the noise filter circuit 31.

The main substrate 13 includes a main controller 33 and a main power supply circuit 32. The motor drive device 15 includes motor drive circuitry 21, inverter control circuitry 22, and a relay 17. The motor drive circuitry 21 includes a rectification diode 58, a DC reactor 57, a main electrolytic capacitor 56, and an inverter circuit 55. The relay 17 is provided between the motor drive circuitry 21 and the motor 16. The relay 17 is connected to power lines through which a DC voltage is applied from the motor drive circuitry 21 to the motor 16. In Embodiment 1, it is assumed that the relay 17 is a thermal relay.

The inverter control circuitry 22 includes a motor controller 43, a motor-control power supply circuit 52, a drive circuit 53, a smoothing capacitor 64, an overcurrent detection circuit 65, a reset circuit 66, a latch circuit 67, a current detection circuit 70, a bus-voltage detection circuit 71, and a connector 51. The main controller 33 and the motor controller 43 are connected by a communication line 14 to transmit and receive information to and from each other through the communication line 14.

First of all, a configuration of the main substrate 13 will be described. The main power supply circuit 32 converts single-phase voltages from the noise filter circuit 31 through the two output lines to a main-control voltage for the main controller 33 and a motor-control voltage 62 for the motor drive device 15. The main power supply circuit 32 applies the main-control voltage to the main controller 33. The main-control voltage is, for example, 3.3 V or 5 V. The main power supply circuit 32 applies the motor-control voltage 62 to the motor drive device 15 through a first power supply line 44 and a second power supply line 45. The motor-control voltage 62 is, for example, 15 V to 20, and is a voltage necessary for an operation of the inverter circuit 55. In the case where the second power supply line 45 is at the ground potential, a voltage of +15 V to 20 V is applied to the first power supply line 44.

The outdoor unit 1 of the air-conditioning apparatus 100 is provided with a plurality of actuators that need an adequate voltage for a proper operation. The actuators that need the adequate voltage for the proper operation are, for example, an electronic expansion valve, a solenoid valve, a relay, and a magnet (all not illustrated) in addition to the motor 16 for the compressor 3 and the fan 5. The main power supply circuit 32 generates a voltage that is necessary for each of these actuators. However, since the main power supply circuit 32 is not directly related to the motor drive device, its detailed description will thus be omitted.

As described above, the main power supply circuit 32 generates the motor-control voltage 62 that is a source of a power supply for the plurality of actuators and a source of a power supply for driving the drive circuit 53 and the motor controller 43 to operate. It should be noted that the main power supply circuit 32 may be provided in the motor drive device 15.

The main controller 33 is, for example, a microcomputer. The main controller 33 transmits and receives information to and from the motor controller 43 of the motor drive device 15 through the communication line 14 via serial communication or other type of communication. The information to be transmitted from the main controller 33 to the motor controller 43 is, for example, setting information related to operation of the air-conditioning apparatus 100, and parameters for driving the motor 16 for the compressor 3 and the fan 5

Next, a configuration of the motor drive device 15 will be described. First of all, a configuration of the motor drive circuitry 21 will be described. The rectification diode 58 converts an AC voltage which is output from the power supply system 11 through the noise filter circuit 31, to a DC bus voltage. The DC reactor 57 reduces the probability that a harmonic current that is generated when the inverter circuit 55 operates will flow out to the power supply system 11. The main electrolytic capacitor 56 smooths a bus voltage that is output from the rectification diode 58 through two buses. Information on a potential difference between terminals of the main electrolytic capacitor 56 is input to the bus-voltage detection circuit 71 through a signal line (not illustrated).

The inverter circuit 55 includes a plurality of switching elements that are semiconductor elements such as an insulated gate bipolar transistor (IGBT) and a metal oxide semiconductor field effect transistor (MOS-FET). The number of switching elements corresponds to the number of phases of the motor 16. For example, in a three-phase inverter for a U-phase, a V-phase, and a W-phase, the inverter circuit 55 includes six switching elements. In a single-phase inverter, the inverter circuit 55 includes four switching elements.

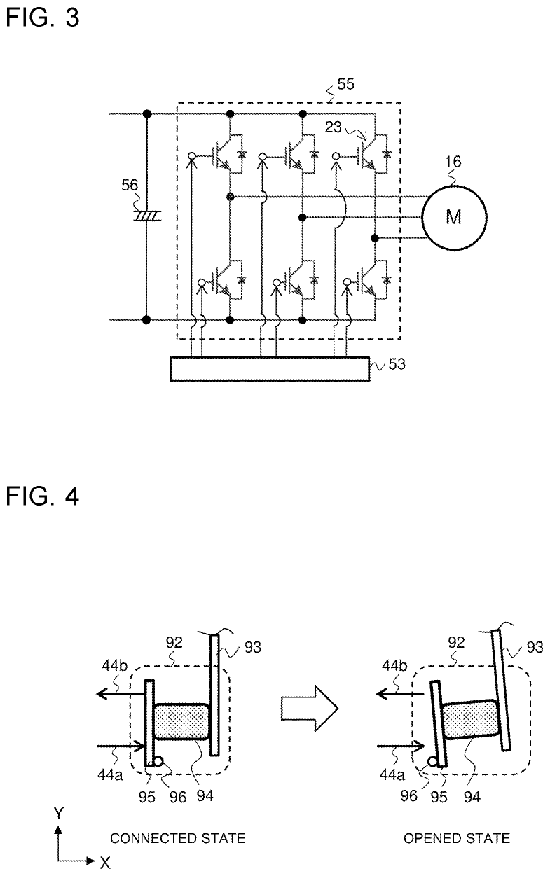

FIG. 3 is a circuit diagram illustrating a configuration example of the inverter circuit as illustrated in FIG. 2. The inverter circuit 55 as illustrated in FIG. 3 is a three-phase inverter having six switching elements 23. Each of the switching elements 23 operates in response to a drive signal that is input from the drive circuit 53 through a drive signal line 54 as illustrated in FIG. 2. The drive signal is, for example, a pulse width modulation (PWM) control signal. Each of the switching elements 23 performs a switching operation in response to the PWM control signal, whereby the inverter circuit 55 supplies an AC voltage corresponding to the PWM control signal to the motor 16 to drive the motor 16.

At one of the two buses between the rectification diode 58 and the inverter circuit 55, a bus-current detection circuitry 68 is provided. The bus-current detection circuitry 68 is, for example, a shunt resistance or a Hall effect element. The bus-current detection circuitry 68 detects an overcurrent that flows through the bus. The bus-current detection circuitry 68 is connected to the overcurrent detection circuit 65 in the inverter control circuitry 22. The bus-current detection circuitry 68 outputs information

Current detection circuitry 69a and 69b are provided between the inverter circuit 55 and the motor 16. The current detection circuitry 69a and 69b are connected to the current detection circuit 70 in the inverter control circuitry 22. The current detection circuitry 69a and 69b detect a motor current that is supplied from the inverter circuit 55 to the motor 16, and output information on the detected motor current to the current detection circuit 70. The current detection circuitry 69a and 69b are each, for example, a resistance element.

Next, a configuration of the inverter control circuitry 22 will be described with reference to FIG. 2. The connector 51 includes a first terminal 46 and a second terminal 47. To the first terminal 46, the first power supply line 44 is connected via the relay 17. The first power supply line 44 is one of the two power supply lines extending from the main power supply circuit 32. To the second terminal 47, the second power supply line 45 is connected. The second power supply is the other of the above two power supply lines. The drive circuit 53 and the motor-control power supply circuit 52 are connected in parallel with each other to the connector 51. That is, two power supply lines connecting the connector 51 and the drive circuit 53 branch into branch power supply lines, and the branch power supply lines are connected to the motor-control power supply circuit 52. The motor-control voltage 62 to be applied from the connector 51 to the drive circuit 53 will be referred to as “inverter drive voltage 61.” The motor-control voltage 62 to be applied from the connector 51 to the motor-control power supply circuit 52 will be referred to as “inverter control voltage 63.”

The smoothing capacitor 64 smooths the inverter control voltage 63. The motor-control power supply circuit 52 converts the inverter control voltage 63 input through the connector 51 to an operating voltage for the motor controller 43, and supplies the converted operating voltage to the motor controller 43. The operating voltage is, for example, 3.3 V or 5 V.

The motor controller 43 is connected to the bus-voltage detection circuit 71, the latch circuit 67, the current detection circuit 70, the reset circuit 66, and the drive circuit 53. The bus-voltage detection circuit 71 outputs information on the potential difference between the terminals of the main electrolytic capacitor 56 to the motor controller 43.

The overcurrent detection circuit 65 is connected to the latch circuit 67. The overcurrent detection circuit 65 holds a second threshold in advance that is a criterion for determination of whether the bus current is an overcurrent or not. The overcurrent detection circuit 65 determines whether the bus current is higher than or equal to the second threshold, and outputs an overcurrent detection signal to the latch circuit 67 when the bus current is higher than or equal to the second threshold. When receiving the overcurrent detection signal from the overcurrent detection circuit 65, the latch circuit 67 holds the overcurrent detection signal, and outputs the overcurrent detection signal to the motor controller 43 and the drive circuit 53.

When receiving information on a motor current from the current detection circuitry 69a and 69b, the current detection circuit 70 transmits the information on the motor current to the motor controller 43. The current detection circuit 70 holds a third threshold in advance that is a criterion for determination of whether the motor current is an overcurrent or not. The current detection circuit 70 determines whether the motor current is higher than or equal to the third threshold, and outputs an overcurrent detection signal to the motor controller 43 when the motor current is higher than or equal to the third threshold. When receiving a reset signal input from the outside, the reset circuit 66 transmits the reset signal to the motor controller 43.

The motor controller 43 is, for example, a microcomputer. The motor controller 43 controls the drive circuit 53 based on the setting information related to the air-conditioning apparatus 100 and the information on parameters for driving the motor 16, and based on the information on the potential difference which is received from the bus-voltage detection circuit 71 and the information on the motor current which is received from the current detection circuit 70. For example, the motor controller 43 controls the potential difference that is received as the information from the bus-voltage detection circuit 71 such that the potential difference falls within a determined reference range, generates control information including such parameter information as to allow the value of the motor current to be made closer to a value corresponding to the setting information, and then transmits the generated control information to the drive circuit 53.

When receiving the overcurrent detection signal from the latch circuit 67 or the current detection circuit 70, the motor controller 43 transmits, to the drive circuit 53, a deactivation signal that instructs the drive circuit 53 to deactivate itself. When the supply of the operating voltage from the motor-control power supply circuit 52 is stopped, the motor controller 43 stops the control of the drive circuit 53. The motor controller 43 transmits information related to the operation of the motor drive device 15, such as the bus voltage or the motor current, and feedback information on the control of the motor 16 to the main controller 33 in real time through the communication line 14.

To the drive circuit 53, the inverter drive voltage 61 is applied through the connector 51. The drive circuit 53 applies the inverter drive voltage 61 to the inverter circuit 55 through a power line (not illustrated). The drive circuit 53 generates a PWM control signal to drive the motor 16 in accordance with the setting information, based on the control information received from the motor controller 43. The drive circuit 53 outputs a PWM waveform signal to the inverter circuit 55 through the drive signal line 54.

When receiving the deactivation signal from the motor controller 43, the drive circuit 53 stops the operation of outputting the PWM waveform signal. When receiving the overcurrent detection signal from the latch circuit 67, the drive circuit 53 stops the operation of outputting the PWM waveform signal. Even if a failure occurs in the motor controller 43 or the latch circuit 67, it is still possible to stop the output from the inverter circuit 55.

When receiving the deactivation signal from the motor controller 43 and receiving the overcurrent detection signal from the latch circuit 67, the drive circuit 53 stops its operation in response to one of these signals that is received earlier by the drive circuit 53. Since the drive circuit 53 stops the operation of outputting the PWM waveform signal in response to an abnormality notification signal that is received earlier by the drive circuit 53, it is possible to stop the output from the inverter circuit 55 earlier.

Next, a configuration of the relay 17 as illustrated in FIG. 2 will be described. The relay 17 includes current detection circuitry 91 and relay circuitry 92. The current detection circuitry 91 is provided at power lines through which a motor current is supplied from the inverter circuit 55 to the motor 16. The current detection circuitry 91 is made of material having such properties that the material is deformed into a line shape by generated heat. The material of the current detection circuitry 91 is, for example, bimetal. The current detection circuitry 91 is deformed by generated heat when the motor current reaches a first threshold or higher that is determined in advance.

The relay circuitry 92 switches the state of the first power supply line 44 between a connected state and an opened state. The first power supply line 44 is one of the two power supply lines that are the first power supply line 44 and the second power supply line 45 through which a control voltage is applied to the drive circuit 53. When the current detection circuitry 91 is deformed, the relay circuitry 92 switches the state of the first power supply line 44 from the connected state to the opened state.

FIG. 4 is a schematic diagram illustrating an example of an operating principle of the relay circuitry. As a matter of convenience for explanation, in FIG. 4, arrows are shown to indicate two axes (X-axis and Y-axis) that define directions. FIG. 4 illustrates an enlarged view of the relay circuitry and a peripheral area thereof. The current detection circuitry 91 is made up of bimetals 93. The bimetals 93 are provided at respective three power lines. However, in order to simply an explanation of this configuration, the following description is made with respect to a single bimetal 93 provided at a single power line. In the relay circuitry 92, a metal plate 95 is attached to one end of the bimetal 93, with an insulator 94 interposed between the metal plate 95 and the bimetal 93. The insulator 94 is, for example, a synthesis resin.

In the connected state as illustrated in FIG. 4, a first power supply line 44a extending from the main power supply circuit 32 to the relay circuitry 92 is electrically connected to a first power supply line 44b extending from the relay circuitry 92 to the connector 51, by the metal plate 95. A latch pin 96 is provided to latch the state of the relay circuitry 92. The latch pin 96 is an insulating pin formed in the shape of a bar, and is flexible only in a direction determined in advance. With reference to FIG. 4, the latch pin 96 will be described. The latch pin 96 can be bent in a direction along the X-axis in FIG. 4, and cannot be bent in the opposite direction to the direction along the X-axis in FIG. 4. The latch pin 96 as illustrated in FIG. 4 is fixed to an insulating plate (not illustrated).

In the connected state as illustrated in FIG. 4, when the motor current reaches the first threshold or higher, the bimetal 93 is deformed and bent by heat generation. As a result, in the opened state as illustrated in FIG. 4, the insulator 94 and the metal plate 95 are separated from the first power supply line 44a and the first power supply line 44b, and the metal plate 95 is moved to pass by the latch pin 96. The latch pin 96 prevents the metal plate 95 from moving back to the original position. The first power supply line 44a and the first power supply line 44b are kept separated from the metal plate 95. In such a manner, the supply of power from the main power supply circuit 32 to the connector 51 is stopped. The current that flows through the first power supply lines 44a and 44b is smaller than the motor current that flows from the inverter circuit 55 to the motor 16 through the power lines. Therefore, as illustrated in FIG. 4, even when the first power supply lines 44a and 44b are separated from the metal plate 95, and the state is switched from the connected state to the opened state, the internal circuit of the motor drive device 15 is not greatly affected.

As thermal relays, an automatic-return type of thermal relay and a manual-return type of thermal relay are present. In the automatic-return type of thermal relay, when the temperature of the thermal relay drops as the motor current decreases to a value smaller than a threshold determined in advance, then a contact of the relay returns to its original position and the supply of the motor current to the motor is re-started. The relay 17 as illustrated in FIG. 4 is a manual-return type of thermal relay. Thus, as described above with reference to FIG. 4, once the relay 17 is caused to be in the opened state, a latch function is activated. Accordingly, the contact does not return to its original position even when the temperature of the bimetal 93 drops as the motor current decreases. In the case where the relay is the manual-return type of thermal relay, the contact is not returned to its original position unless a worker manually disengages the latch. In the case where the relay is the automatic-return type of thermal relay, even when the supply of a current is stopped by the relay, the contact still automatically returns to its original position. Thus, a large current frequently flows through the motor, and as a result, the motor may be overheated. In contrast, in Embodiment 1, since the relay 17 is of manual-return type, the relay 17 can prevent a large current from frequently flowing through the motor 16.

It should be noted that although the above description is made with reference to FIG. 4 by referring to the case where the relay 17 is a thermal relay, the relay 17 has only to have a function of stopping application of the control voltage to the drive circuit 53 when the motor current becomes excessive regardless of what software is applied. Therefore, the relay 17 in Embodiment 1 is not limited to the thermal relay. FIG. 4 is an explanatory view for explanation of the operating principle of the relay 17, and thus the configuration of the relay 17 is not limited to the configuration as illustrated in FIG. 4.

Next, an operation of the motor drive device 15 in Embodiment 1 will be described. When an AC power supply voltage is applied from the power supply system 11 to the controller 12, the power supply voltage passes through the noise filter circuit 31. The power supply voltage that has passed through the noise filter circuit 31 is converted from an AC power supply voltage to a DC power supply voltage by the rectification diode 58. The DC power supply voltage obtained through the conversion is smoothed by the main electrolytic capacitor 56 and obtained as a smooth bus voltage for the inverter circuit 55.

The main power supply circuit 32 converts a single-phase voltage applied from the noise filter circuit 31 to the motor-control voltage 62 that is a voltage for the motor drive device 15, and applies this motor-control voltage 62 to the motor drive device 15. The motor-control voltage 62 is applied from the main power supply circuit 32 to the motor drive device 15 through the first power supply line 44 and the second power supply line 45. The motor-control voltage 62 is applied to the drive circuit 53 through the relay 17 and the connector 51. Furthermore, the motor-control voltage 62 branches off from the connector 51 and is thus applied to the motor-control power supply circuit 52. The operating voltage is applied from the motor-control power supply circuit 52 to the motor controller 43.

The motor controller 43 produces control information including such parameter information as to allow the value of motor current to be made closer to a value corresponding to the setting information, and then transmits the produced control information to the drive circuit 53. The drive circuit 53 produces a PWM control signal to drive the motor 16 in accordance with the setting information, based on the control information received from the motor controller 43. The drive circuit 53 outputs the PWM waveform signal to the inverter circuit 55 through the drive signal line 54. The inverter circuit 55 applies an AC voltage corresponding to the PWM control signal to the motor 16 through the power lines to drive the motor 16.

Next, an operation of the relay 17 will be described. The current detection circuitry 91 is deformed by heat generation when the motor current from the inverter circuit 55 reaches the first threshold or higher. When the current detection circuitry 91 is deformed, the relay circuitry 92 switches the state of the first power supply line 44 from the connected state to the opened state. As a result, the application of the motor-control voltage 62 to the drive circuit 53 and the motor-control power supply circuit 52 through the first power supply line 44 and the second power supply line 45 is stopped, thereby stopping the supply of power to the drive circuit 53 and the motor controller 43. Thus, one or both of the drive circuit 53 and the motor controller 43 stops its or their operation, and the output from the inverter circuit 55 is stopped. It is therefore possible to prevent damage to the motor 16 that would be caused when the motor current would be an overcurrent.

A relationship between thresholds that are used as criteria for determination of whether an overcurrent is generated or not will be described. As described above, in the motor drive device 15 in Embodiment 1, whether an overcurrent is generated or not is determined at three locations. Specifically, the relay 17 determines whether the motor current detected by the current detection circuitry 91 is higher than or equal to the first threshold or not. The overcurrent detection circuit 65 determines whether the current detected by the bus-current detection circuitry 68 is higher than or equal to the second threshold or not. The current detection circuit 70 determines whether the motor current detected by the current detection circuitry 69a and 69b is higher than or equal to the third threshold or not.

In Embodiment 1, it is preferable that the following formula (1) be satisfied:

Thc3<Thc2<Thc1<Maxc (1)

where Thc1 is the first threshold, Thc2 is the second threshold, Thc3 is the third threshold, and Maxc is an upper-limit value of such a current as to ensure insulation properties of the winding of the motor 16.

In the case where the above thresholds and upper-limit value are set to satisfy the formula (1), during normal operation of the inverter circuit 55, the supply of power to the drive circuit 53 is prevented from being stopped by the relay 17. Even if the insulation properties of the winding of the motor 16 are degraded by heat, it is still possible to deactivate the motor 16 before an earth fault occurs in the winding.

In Embodiment 1, an example of how the motor 16 operates when abnormally operating will be described below. When being brought into a locked state, the motor 16 for the compressor 3 or the fan 5 causes a loss of synchronization, and an overcurrent flows through the winding of the motor 16. Basically, one or both of the overcurrent detection circuit 65 and the current detection circuit 70 detect the overcurrent, and it is thus possible to deactivate the motor 16 safely. However, for example, because a failure occurs in the overcurrent detection circuit 65, the current detection circuit 70, and the motor controller 43, there is a possibility that a protection function of an electrical abnormality avoidance system by the above circuits may not work. In Embodiment 1, even if the electrical anomaly avoidance system does not work, the relay 17 operates. A mechanical anomaly avoidance system by the relay 17 reliably operates without relying on software and sensors. Thus, as described above, the supply of power to the drive circuit 53 and the motor controller 43 can be stopped, and the motor 16 can be safely deactivated.

The motor drive device 15 in Embodiment 1 includes the inverter circuit 55 which drives the motor 16, the drive circuit 53 to which the control voltage is applied and which outputs a drive signal to the inverter circuit 55, and the relay 17 which stops application of the control voltage to the drive circuit 53. The relay 17 detects a motor current that is output from the inverter circuit 55 to the motor 16, and stops application of the control voltage to the drive circuit 53 when the motor current reaches the first threshold or higher.

In Embodiment 1, even though an electromagnetic contactor configured to stop the supply of the motor current is not provided at a power line through which the motor current is supplied to the motor, when the motor current reaches the first threshold or higher, the relay 17 stops application of the control voltage to the drive circuit 53, and can thus stop the output from the inverter circuit 55. Since an electromagnetic contactor is not provided, the overheat protection system can be simplified and production costs of the motor drive device 15 can thus be reduced. In addition, the motor drive device detects the motor current without detecting the temperature of the outer shell of the motor 1, and is not greatly affected by an environmental temperature. Accordingly, the reliability of protection of the motor 16 from an overcurrent is improved.

In Embodiment 1, the motor drive device 15 may include the overcurrent detection circuit 65 which outputs an overcurrent detection signal to the motor controller 43 when a current that flows through the bus is higher than or equal to the second threshold, and the current detection circuit 70 which outputs an overcurrent detection signal to the motor controller 43 when the motor current is higher than or equal to the third threshold. In this case, the motor 16 is protected by a combination of the electrical abnormality avoidance system including the overcurrent detection circuit 65 and the current detection circuit 70 and the mechanical abnormality avoidance system by the relay 17. Basically, the electrical abnormality avoidance system works: however, even when the electrical abnormality avoidance system does not work because of, for example, occurrence of an abnormality in software or occurrence of a failure in sensors, the mechanical abnormality avoidance system reliably operates without relying on the software and sensors. It is therefore possible to reliably protect the motor 16.

An existing overheat protection device that determines whether an overcurrent is generated or not with reference to a threshold, based on the temperature of the outer shell of a motor for a compressor and a fan, may be affected by an environmental temperature that is an ambient temperature around the actuator, and may thus malfunction. For example, in a motor provided in the fan, airflow generated by the fan cools the surface of the motor, and as a result, the difference between the actual temperature of the winding of the motor and the temperature of the outer shell of the motor may be great. The temperature of the outer shell of the motor may sometimes be lower than the actual temperature of the winding of the motor. In this case, if a threshold is not set in consideration of the difference between the temperature of the winding of the motor and the temperature of the outer shell of the motor, there may be a risk that the winding of the motor will be burned out before the protection function of the overheat protection device starts working.

In the case where the actuator is a compressor, the winding of the motor is cooled by refrigerant in the compressor, and a sufficient temperature margin for the winding of the motor is allowed; however, none the less, the temperature of the outer shell of the motor may be increased, for example, when the ambient temperature around the compressor is high. In this case, the existing overheat protection device deactivates the motor earlier than when an overcurrent is generated.

In contrast, in the outdoor unit 1 of the air-conditioning apparatus 100 in Embodiment 1 is not greatly affected by an environmental temperature of an actuator such as the compressor or the fan. Thus, the protection function works properly when an abnormality occurs. Thus, the reliability of the overheat protection device is improved as compared with the existing overheat protection device.

As described above regarding Embodiment 1, in the air-conditioning apparatus 100 as illustrated in FIG. 1, the motor drive device 15 is applied to a device configured to drive the motor 16 provided in the compressor 3 and a device configured to drive the motor 16 provided in the fan 5. Hereinafter, the motor drive device 15 configured to drive the motor 16 provided in the compressor 3 will be referred to as “first motor drive device,” and the motor drive device 15 configured to drive the motor 16 provided in the fan 5 will be referred to as “second motor drive device.” It is preferable that a compressor relay threshold that is the first threshold Thc1 set for the first motor drive device be set to a value greater than a fan relay threshold that is the first threshold Thc1 set for the second motor drive device. The following are reasons for this.

Since in the compressor 3, a larger current flows through the motor 16 than in the fan 5, the relay 17 provided in the first motor drive device of the compressor 3 has greater current-proof characteristics than the relay 17 provided in the second motor drive device of the fan 5. Therefore, in the case where the compressor relay threshold is set to a value smaller than or equal to the fan relay threshold, the relay 17 may not function when it is necessary to stop the supply of current to the motor 16 of the compressor 3. In addition, the relay 17 may frequently stop the supply of current even when it is unnecessary to do so. In order to prevent such an occurrence, the compressor relay threshold is set to a value greater than the fan relay threshold.

Although the air-conditioning apparatus 100 according to Embodiment 1 is described above with reference to the figures, the characteristics of the overheat protection system are not limited to those explained by the above descriptions of the above embodiment.

### REFERENCE SIGNS LIST

1: outdoor unit, 2: indoor unit, 3: compressor, 4: heat-source-side heat exchanger, 5: fan, 6: four-way valve, 7: load-side heat exchanger, 8: expansion valve, 9: fan, 10: refrigerant circuit, 11: power supply system, 12: controller, 13: main substrate, 14: communication line, 15: motor drive device, 16: motor, 17: relay, 21: motor drive circuitry, 22: inverter control circuitry, 23: switching element, 31: noise filter circuit, 32: main power supply circuit, 33: main controller, 43: motor controller, 44, 44a, 44b: first power supply line, 45: second power supply line, 46: first terminal, 47: second terminal, 51: connector, 52: motor-control power supply circuit, 53: drive circuit, 54: drive signal line, 55: inverter circuit, 56: main electrolytic capacitor, 57: DC reactor, 58: rectification diode, 61: inverter drive voltage, 62: motor-control voltage, 63: inverter control voltage, 64: smoothing capacitor, 65: overcurrent detection circuit, 66: reset circuit, 67: latch circuit, 68: bus-current detection circuitry, 69a, 69b: current detection circuitry, 70: current detection circuit, 71: bus-voltage detection circuit, 91: current detection circuitry, 92: relay circuitry, 93: bimetal, 94: insulator, 95: metal plate, 96: latch pin, 100: air-conditioning apparatus.

1. A motor drive device comprising:
an inverter circuit configured to drive a motor;
a power supply circuit configured to produce a control voltage from an AC power supply;
a drive circuit to which the control voltage is applied from the power supply circuit, the drive circuit being configured to output a drive signal to the inverter circuit; and
a relay configured to stop application of the control voltage to the drive circuit,
wherein the relay is configured to detect a motor current that is output from the inverter circuit to the motor, and to stop application of the control voltage to the drive circuit when the motor current reaches a first threshold or higher that is determined in advance.

2. The motor drive device of claim 1, wherein
the relay is a thermal relay,
the thermal relay includes
current detection circuitry provided at a power line through which the motor current is supplied from the inverter circuit to the motor, and
relay circuitry configured to switch a state of one of two power supply lines through each of which the control voltage is applied to the drive circuit, between a connected state and an opened state,
the current detection circuitry is deformed when the motor current reaches the first threshold or higher, and
the relay circuitry is configured to switch the state of the one power supply line from the connected state to the opened state, when the current detection circuitry is deformed.

3. The motor drive device of claim 2, further comprising:
a connector having a first terminal and a second terminal, the one power supply line being connected to the first terminal through the relay circuitry, an other one of the two power supply lines being connected to the second terminal; and
a controller to which an operating voltage based on the control voltage is applied, the controller being configured to control the drive circuit, the control voltage being output from the connector and branching off to be applied,
wherein the controller is configured to stop controlling the drive circuit when the thermal relay stops application of the control voltage.

4. The motor drive device of claim 3, further comprising a rectification diode configured to convert an AC voltage that is applied the AC power supply to a DC bus voltage,
wherein to the connector, the control voltage is applied from the power supply circuit, the power supply circuit being connected to an output line that branches off from a location between the AC power supply and the rectification diode, the power supply circuit being configured to convert the AC voltage to the control voltage,
the first terminal is connected to the power supply circuit by the one power supply line through the relay circuitry, and
the second terminal is connected to the power supply circuit by the other power supply line.

5. The motor drive device of claim 4, further comprising:
an overcurrent detection circuit configured to determine whether a current that flows through a bus is higher than or equal to a second threshold determined in advance, and to output an overcurrent detection signal to the controller when the current that flows through the bus is higher than or equal to the second threshold, the bus being used to allow the bus voltage to be applied therethrough from the rectification diode to the inverter circuit; and
a current detection circuit configured to determine whether the motor current supplied from the inverter circuit to the motor is higher than or equal to a third threshold determined in advance, and to output an overcurrent detection signal to the controller when the motor current is higher than or equal to the third threshold,
wherein the controller is configured to deactivate the drive circuit when the controller receives the overcurrent detection signal from the overcurrent detection circuit or the current detection circuit.

6. The motor drive device of claim 5, further comprising a latch circuit provided between the overcurrent detection circuit and the controller, the latch circuit being configured to hold the overcurrent detection signal received from the overcurrent detection circuit, and to output the overcurrent detection signal to the controller and the drive circuit,
wherein the controller is configured to transmit a deactivation signal to deactivate the drive circuit when the controller receives the overcurrent detection signal, and
wherein the drive circuit is configured to stop an operation thereof in response to one of the deactivation signal received from the controller or the overcurrent detection signal received from the latch circuit, the one of the deactivation signal and the overcurrent detection signal being received earlier by the drive circuit.

7. The motor drive device of claim 5, wherein a relationship between the first threshold, the second threshold, and the third threshold is expressed by the first threshold>the second threshold>the third threshold.

8. The motor drive device of claim 1,
wherein
the motor drive device is configured to drive the motor provided in a compressor, the compressor being one of actuators included in a refrigeration cycle circuit, and
the first threshold set to drive the motor provided in the compressor is greater than the first threshold set for a fan that is one of actuators included in the refrigeration cycle circuit.

9. An outdoor unit of an air-conditioning apparatus, comprising:
an actuator forming part of a refrigeration cycle circuit;
a motor provided in the actuator; and
the motor drive device of claim 1, the motor drive device being configured to drive the motor.

10. The outdoor unit of the air-conditioning apparatus of claim 9, comprising a compressor, a heat-source-side heat exchanger, and a fan as actuators forming part of the refrigeration cycle circuit, the compressor being configured to compress and discharge refrigerant, the heat-source-side heat exchanger being configured to cause heat exchange to be performed between the refrigerant and outside air, the fan being configured to supply the outside air to the heat-source-side heat exchanger, the outdoor unit further comprising:
a first motor drive device provided as the motor drive device configured to drive a motor provided in the compressor; and
a second motor drive device provided as the motor drive device configured to drive a motor provided in the fan, and
a compressor relay threshold that is the first threshold set for the first motor drive device is greater than a fan relay threshold that is the first threshold set for the second motor drive device.
